(19) United States
(12) Patent Application Publication
(10) Pub. No.: US 2012/0057225 A1
(43) Pub. Date: Mar. 8, 2012

(54) EXPEDIENT OF REGULATION OF THE DIRECTIONAL GEAR TRANSMISSION OF LIGHT

(76) Inventor: Rustam Sabirovich Zakirullin, Orenburg (RU)

(21) Appl. No.: 13/138,812

(22) PCT Filed: May 11, 2010
(86) PCT No.: PCT/RU2010/000234

§ 371 Date: Sep. 29, 2011

(51) Int. Cl. G02B 5/22

(52) U.S. Cl. 359/359; 359/613

(57) ABSTRACT

The invention relates to fields of technique where the glazed constructions are applied and regulation of their directional gear transmission of light depending on angle of incidence of beams is required at the motion of a light source and/or the glazed construction from each other. Regulation is carried out both spontaneously under activity of optical legitimacies (FIG. 1), and forcedly by manufacturing of one or several surfaces of the construction in a form of alternating strips with the non-uniform optical and geometrical parameters, located so that at different angles of incidence through all glazed area equally or with zone allocation only the demanded and certain in advance part of beams of the necessary diapason of wave lengths transited directionally, but other part of beams—was reflected, absorbed and diffused (FIG. 11). Thus depending on angles of incidence of beams selective regulation both of quantities of beams (values of light streams), transiting through the glazed construction directionally, dispersionless, and of directions of transiting beams is carried out.

### TECHNICAL FIELD

This invention can be applied in architecture and construction at a glazing of light apertures, in transport mechanical engineering at a glazing of windows and other parts of body (fuselage, etc.), in manufacture of lighting equipment, glasses, eyepieces, objectives, and also in other fields of technique in which the glazed constructions are used, and relates in the core to those cases when a light source and/or the glazed object move from each other, that is, an angle of incidence of light beams on a receiving surface changes in time.

### BACKGROUND ART

In any glazed construction irrespective of its scope the partial gear transmission of the impinging light stream is supposed, other part is reflected and absorbed. It is known, that impinging light stream Φ₀, lm, is parted on three components: reflected Φ_{ρ}, transiting Φ_{τ}, and absorbed Φ_{α} light streams, lm:

(Φ₀=Φ_{ρ}+Φ_{τ}+Φ_{α}.

Coefficients of reflection ρ, gear transmission τ and absorption α of light of the definite wave length are bound by a relation:

ρ+τ+α=1.

The most spread use of glass is building construction where sunlight is the light source. The architectural glass passes sunlight of the wave length from 280 up to 2150 nm, that is, ultraviolet, visible and infrared diapasons of the spectrum of sunlight, therefore the gear transmission of light of glass is characterized by a great number of parameters, basic of which are: LT—a gear transmission of light in visible area between 380 and 780 nm, UV—a gear transmission of ultraviolet radiation from 280 up to 380 nm, DET—a direct gear transmission of solar energy between 300 and 2150 nm, SF—a solar factor—the total passed energy including, except DET, also energy, radiated by glass inside of a room after absorption of a part of impinging energy by it, that is, the concept of gear transmission of light is bound as well to concept of gear transmission of heat. Detailed terminology of characteristics of glass is given in materials of sites:

<http://www.glassfiles.com/>
<http://www.sibsteklo.ru/>
<http://esco-ecosys.narod.ru/2004_6/art61.htm>

Characteristics of the gear transmission of light of glass in other fields of its application on sense do not differ essentially from enumerated above ones and get out depending on a type of light source and importance of those or other components of gear transmission of light and heat in a concrete field.

Depending on purpose of the glazed construction different relations between three parted components of impinging light stream are required. These relations are regulated by application of a great number of various types of glass among which are: usual (not polished), float-glass (polished), reinforced, laminated (multilayered), sun-protection (colored in mass or with a coat), figured, selective (<<low-e>> glass, versions: k-glass—with a solid coat and i-glass—with a soft coat), tempered, <<soft>> self-cleaned, and coated with films of various purpose glass. Reference data about yielding in present time types of glass are given on sites:

<http://steklo.h1.ru/standarts.shtml/>
<http://www.interstroy21.com.ua/>
<http://ufa.shikremont.ru/okna/stekla.php>

The relation of three parts of the light stream for each type of glass depends on the angle of incidence of light beams on the receiving surface of the glazed construction, and changes at a motion of the light source and/or the glazed construction from each other. In case of glazing of light apertures in buildings and constructions this angle varies depending on a geographical position of object and a season. In case of glazing of vehicles the angle of incidence in addition depends also on requirements of a motion of the vehicle.

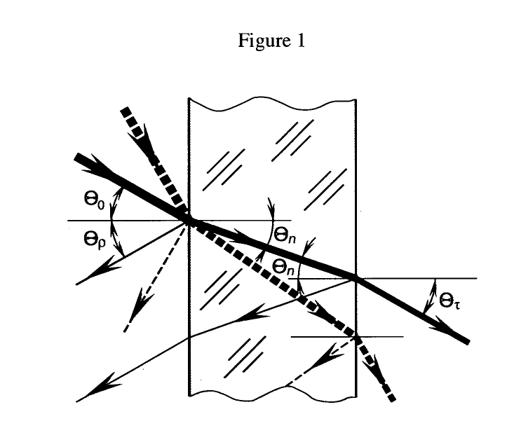

Let's view gear transmission of light of a leaf glass with thickness of 4 mm (FIG. 1, gauge 10:1) within the limits of applicability of rules of geometrical optics. It is known, that from the angle Θ₀ of incidence of light beam on the surface of glass the angles of reflection Θ_{ρ} (Θ_{ρ}=Θ₀) and refractive Θₙ of the beam depend, sin Θ₀=n sin Θₙ (Snell's law), where n—an exponent of the refractive of glass. For a plane-parallel glass at identical surroundings on both sides from it: Θ_{τ}=Θ₀, where Θ_{τ}—the angle of slope of the transited beam. Trajectories of transiting of beams are figured on FIG. 1 with continuous lines for Θ₀=30° (the exponent of the refractive of glass is accepted n=1.5) and with dotted lines for Θ₀=60°. Accordingly, refraction angles of beams are: Θₙ=19° 28^{I} 12^{II} and Θₙ=35° 15^{I} 36^{II}. The impinging light streams falling a unit area, and the incident intensities related to them at both angles are taken identical. In the most spread cases of application of the glazed constructions the most part of light stream transits through glass, only inappreciable part is reflected and absorbed.

It is known, that at magnification of the angle of incidence of beam on the surface reflectivity p is incremented, hence, the reflected part of the light stream is also incremented. From FIG. 1 it is visible, that length of a trajectory of transiting of the beam through material, influencing on value of the absorbed light stream, also depends on the angle of incidence of beam on the surface (in this case the length of trajectory is incremented by 14%). The inappreciable part of the light stream is reflected, then being partially absorbed, also from the boundary surface with surrounding medium at the output of beam from glass (FIG. 1), and it occurs nonsinglely, however this part of the stream can be neglected because of its small size. So, at magnification of angle of incidence the reflected and absorbed light streams increase and the transited light stream decreases. For example, at a double-layer glazing (http://www.nestor.minsk.by/sn/1999/13/sn91317.htm) the coefficient of the gear transmission of light (the attitude of the transited light stream to the impinging one) is accordingly: 0.7 at the zero angle of incidence; 0.686 at 37°; 0.646 at 53°; 0.531 at 66° and 0.265 at 78°. It is visible, that at small angles of incidence the coefficient of the gear transmission of light varies inappreciable, however at magnification of angles it decreases strongly.

Thus, at change of angle of incidence of light beam on the surface of glass at identical incident intensity the relations of coefficients of reflection, absorption and gear transmission of radiation are changed spontaneously and, hence, values of characteristics of the gear transmission of light in ultraviolet, visible and infrared diapasons are changed, because coefficients depend on the wave length of impinging radiation. Besides, according to rules of geometrical optics, at change of the angle of incidence of beam on the receiving surface the angle of slope of the transited through the glazed construction beam also is changed (FIG. 1).

The enumerated features are characteristic for all types of the glass applied in various glazed constructions and optical devices of any shapes, the sizes, properties, purpose and quantity of layers of the glazing. These features are characteristic also for the declared invention, therefore practically any glazed construction is an analog of the invention.

At change of the angle of incidence of light from the light source the part of direct (non-diffused) light which has transited through the glazed construction can cause the undesirable phenomena, for example, occurrence of patches of light and unduly brightly shined surfaces, non-optimum allocation of luminosity inside of the glazed object or device, blinding from direct beams, etc. Therefore at some angles or diapasons of angles of incidence of light on the receiving surface of the glazed construction, necessity of selective regulation of the gear transmission of light and the direction of transiting beams depending on the angle of incidence of beams is appear in addition to viewed above on the example of FIG. 1 spontaneous change of these parameters at change of angle of incidence. The attitude of the light stream which has transited at particular on rules of geometrical optics angle through the glazed construction directionally, without taking into account the transited diffused light stream, to the impinging on the construction at the given angle light stream, is designated in the further by the term <<the directional gear transmission of light>>. At regulation of the directional gear transmission of light of the glazed construction depending on angles of incidence of beams directions of transiting beams and values of light streams transiting in these directions are regulated.

Partially enumerated above problems it is possible to solve by some known expedients, for example, applying a photochrome glass, capable to change the gear transmission of light in visible area at change of intensity of impinging ultraviolet or short-wave visible radiation due to photochemical processes occurring inside the glass (http://www.bse.chemportsu/fotohromnoe_steklo.shtml). It is more in detail featured in the literature: Beregznoi A. I., Sitalls and photositalls, M.: Mechanical engineering, 1966; Tsekhomski V. A., Photochrome glasses, <<Optical-mechanical industry>>, 1967, #7.

Glasses are applied (http://users.iptelecom.net.ua/˜optometr/index05.htm) to correction of vision with multifocal lenses consisting of zones with different exponents of the refractive and intended for regulation of direction of beams, but in passing also zone allocation of the gear transmission of light of the lens is provided. On the same site sun-protection glasses lenses with <<gradient coloring>> are featured which characteristics of the gear transmission of light gradually vary in one direction owing to gradual change of color and/or intensity of painting on a surface of the lens.

One more expedient (http://www.akma.spb.ru/) consists in application of a laminated glass with the adjustable transparence, changing the gear transmission of light in two modes due to orientation of the liquid crystals containing in an interior layer of glass. At the gear transmission of electric current through this layer the liquid crystals are in a ranked state and the glass is transparent, without current the disorder crystals diffuse light and glass is opaque.

The magnification of the gear transmission of light or reflection is reached at application of <<enlightened>> optics due to interference arising at reflection from forward and back surfaces of thin not absorbing layers of a material, superimposing on glass with the thickness depending on wave length of radiation, according to smaller or greater exponent of the refractive in comparison with those for glass (http://bse.sci-lib.com/article093447.html). The literature: The enlightenment of optics, edited by I. V. Grebenchikov, M.-L., 1946; Rosenberg G. V., Optics of thin layer coats, L., 1958; Krylova T. N., The interference coats, L., 1973. Improvement of characteristics of the gear transmission of light in infrared area (the gear transmission of heat) are provided at application in window constructions of <<thermal mirror>> (http://esco-ecosys.narod.ru/2004_{—}6/art60.htm), reflecting thermal beams aside receipts—in a heating period the long-wave radiation is returned in a room, and in a hot season the intensive sunlight is reflected back.

All the expedients enumerated above provide regulation of characteristics of the gear transmission of light, however it is carried out in all cases in dependence not immediately on the angle of incidence of beams, but on other factors, thus there is no direct dependence of the gear transmission of light on angle of incidence of beams and it is not represented to opportunity of additional (to viewed above on FIG. 1) selective regulation of characteristics of the gear transmission of light just in dependence on angle of incidence of beams. For achievement of it the glazed construction should contain various additional devices of redistribution of the light stream, for example, blinds, grilles, shutters, diaphragms which at change of its standing in relation to this glazed construction can provide regulation of the transiting light stream depending on the angle of incidence of beams. Thus, only the combination of the glazed construction and additional devices of redistribution of light provides selective regulation of the directional gear transmission of light depending on angle of incidence of beams on such combined construction.

Shutters, movable grilles and blinds of various types with hand-operated or automatic control when they are applied together with the glazed constructions are the close analogs of the invention (IPC: E06B 9/24 (2010.01)—Screens or other constructions affording protection against light, especially against sunshine; Similar screens for privacy or appearance—for openings in buildings, vehicles, fences, or like enclosures).

The prototype of the invention also relates to this subgroup—the combination of lamellar blinds with windows (IPC: E06B 9/264 (2010.01)—Combinations of lamellar blinds with windows, or double panes, as the device for protection against light, especially against sunshine, and for privacy or appearance). The best selective regulation of the directional gear transmission of light of such combined construction depending on the angle of incidence of beams (on height of standing of the sun) is possible to provide at application of horizontal elevating lamellar blinds with self-acting or hand-operated regulation of the angle of rotation of lamellas depending on height of standing of the sun. Such enclosures are yielding, for example, by company Somfy (http://www.somfy.com/portail/index.cfm). The spontaneous change of the directional gear transmission of light of the window construction is achieved by the scheme presented on FIG. 1, additional selective regulation of the gear transmission of light and directions of transiting beams depending on angle of incidence of beams is achieved due to change of angle of rotation of blinds lamellas, besides the gear transmission of light in the room is regulated on zones due to uprising of lamellas.

Necessity of application of additional devices for redistribution of light streams and their hand-operated or automatic control that leads to complication and rise in price of constructions and to inconveniences of using is deficiency of this expedient of regulation. Besides adjustable devices, for example, horizontal or vertical blinds, because of the complex curvilinear trajectory of the sun cannot provide optimum regulation of the gear transmission of light and directions of transiting light beams at any orientation of the window on the cardinal points (for this purpose blinds with the different angle of slope of lamellas in relation to the standing of the window at the different azimuth of its orientation are necessary). Horizontal blinds are more preferable to the windows of the southern sector, vertical ones—to the east and western sectors. Zone regulation of the gear transmission of light at uprising or shift of lamellas accordingly of horizontal or vertical blinds also is restricted and accessible only in one direction (partitioning into two areas—upper-bottom or right-left). Adjustable devices of redistribution of the light stream are complex, and in some cases are practically impossible in application, for example, on the curvilinear glazed surfaces—on widely applicable in construction and transport bent glasses (in cylindrical, spherical, etc. glazed constructions), and also on the oblique glazed surfaces.

### DISCLOSURE OF INVENTION

The substance of the invention consists in aggregate of the following general features for all cases of its application:

1) Considering shapes, the sizes, purpose, quantity of layers of the glazing, types of applied glasses and optical characteristics of the existing glazed construction, first of all dependence of coefficient of reflection of the receiving surface and directions of beams transiting through the construction, hence, also coefficients of gear transmission and absorption, on angles of incidence of beams on the construction, the characteristic parameters of self-regulation of the directional gear transmission of light, and in view of thermal energy of light also the gear transmission of heat, of glazed construction depending on angles of incidence of beams in the working for this construction diapason of wave lengths (by viewing a two-sided gear transmission incidence of beams of different diapasons from two sides is possible), namely, dependence of the relation of light stream created only by the beams transited directionally through construction (without taking into account the transiting diffused beams) to impinging light stream and directions of transiting of these beams, found by rules of geometrical optics, on angles of incidence of beams on the glazed construction are defined, further, at presence in the construction of additional devices of redistribution of light streams their contribution to general regulation of the directional gear transmission of light depending on angles of incidence of beams are considered, the gained parameters of regulation are compared with demanded ones for this construction purpose, and opportunities for improvement of characteristics of regulation of the gear transmission of light of construction, including zone allocation of the gear transmission of light are defined;

2) Unlike analogs and the prototype, for providing of demanded parameters of regulation of one- or two-sided characteristics of the directional gear transmission of light selectively depending on angles of incidence of beams without application of additional devices of redistribution of light streams or with their restricted application if the offered invention to use as addition to existing devices, in view of optical and geometrical characteristics of the construction and rules of geometrical optics, it is defined, how many and which surfaces of this glazed construction is necessary to make not homogeneous on optical characteristics, but in the form of alternating parallel and/or curvilinear strips with different coefficients of reflection, gear transmission and absorption, having such compositions, exponents of the refractive, geometrical shapes, the sizes, and located from each other both on everyone, and on different non-uniform surfaces with alternating strips, thus, that at the given angles or diapasons of angles of incidence of beams on the glazed construction through all glazed area equally or with zone allocation (consistently through all layers of the glazing and the mediums filling vacuities between them) only demanded at the given angles or diapasons of angles of incidence part of beams of the demanded diapason of wave lengths directionally transited, but other part of beams was reflected, absorbed and diffused, thus for definition of general regulation of the directional gear transmission of light of whole construction changes of parameters of self-regulation because of change of optical properties of surfaces with alternating strips, and also changes of requirements of application of additional devices are considered;

3) Necessary quantity of strips on these particular surfaces of the construction in view of types of the glass used in a concrete case is made by additional zone processings of surfaces by known methods (coloring, diffusion of ions or metals, sandblasting, grinding in, electrolysis, chemical processing, etching, deposition of thermally volatilized substance, drawing of coat {for example, metal and/or metal-oxidic coating on a hot glass by method of pyrolysis or on a cold glass by method of the cathode pulverization in a magnetic field at the deep vacuum}, processing with use of electrical or undular energy, irradiation various particles, drying, dehydration, dehydroxilation, etc.) or a film with strips with different coefficients of reflection, gear transmission and absorption is pasted.

By first feature, characteristic also for analogs and the prototype, self-regulation of the directional gear transmission of light of the glazed construction depending on angles of incidence of beams is carried out, additional regulation is possible only by means of devices of redistribution of light streams. Second and third features—distinctive from analogs and the prototype—provide additional regulation even without such devices. These three basic essential features of the invention allow reach in all cases of its application following technical features:

1) Selective regulation under in advance given law of quantity of beams (values of light streams), transiting through the glazed construction directionally, dispersionless, depending on angles of incidence of beams (IPC: G05D 25/00 (2010.01));

2) Selective regulation under in advance given law of directions of beams, transiting through the glazed construction, depending on angles of incidence of beams (IPC: G05D 3/00 (2010.01)).

The first technical feature is provided by regulation due to in advance calculated parameters of strips and their relative disposition, second—due to different exponents of the refractive of strips. These two technical features are interconnected and in a complex provide selective regulation of the directional gear transmission of light of the glazed construction depending on angles of incidence of beams, thus the invention relates to heading IPC G05D 27/00 (2010.01). It relates also to heading IPC F21V 13/00 (2010.01). In different cases of application of the invention a degree of importance of each feature can be different.

The invention is intended for the solution of following problems (at conservation of shapes, the sizes, the basic purpose of the glazed construction, quantity of layers of the glazing and types of applied glasses):

1) Providing of demanded characteristics of regulation of the directional gear transmission of light of the construction depending on angles of incidence of beams without additional devices of redistribution of light streams that allows to simplify the construction and reduce its price, to refuse from hand-operated or automatic control, to refine appearance, to restrict influence of a dust and other atmospheric phenomena;

2) Expansion of opportunities of combined regulation of the directional gear transmission of light of the construction depending on angles of incidence of beams by application of the invention together with additional devices of redistribution of light streams;

3) Expansion of opportunities of regulation of the directional gear transmission of light of the construction depending on angles of incidence of beams at a complex curvilinear and/or oblique motion of a light source and/or the glazed object from each other;

4) Providing of zone regulation of the gear transmission of light and/or directions of transiting beams depending on angles of incidence of beams at any shapes and the sizes of zones and in any directions on a surface of the glazed construction, including gradual regulation of the gear transmission of light and/or directions of transiting beams;

5) Providing of regulation of the directional gear transmission of light of the construction depending on angles of incidence of beams both for all impinging radiation without change of its spectrum, and samplingly only for the particular part of the spectrum, and also of regulation of the gear transmission of light with different spectral characteristics on different zones and in any direction on the surface of the construction;

6) Expansion of opportunities of regulation of the two-sided directional gear transmission of light, including the gear transmission of heat of the construction, depending on angles of incidence of beams;

7) Expansion of opportunities of regulation of the directional gear transmission of light of the constructions with the curvilinear and/or oblique glazed surfaces depending on angles of incidence of beams.

In each concrete case of application of the invention this or that problem or few problems in any necessary combination can be solved.

Architecture and construction are the major scopes of the invention. The following multipurpose and often inconsistent requirements shown to window constructions relate to the invention: the optimum gear transmission of light at seasons and time of day, protection of a room against excessive illumination intensity and overheat in the hot season and conservation of heat in it in the cold season, providing of privacy and opportunity of the view from the room.

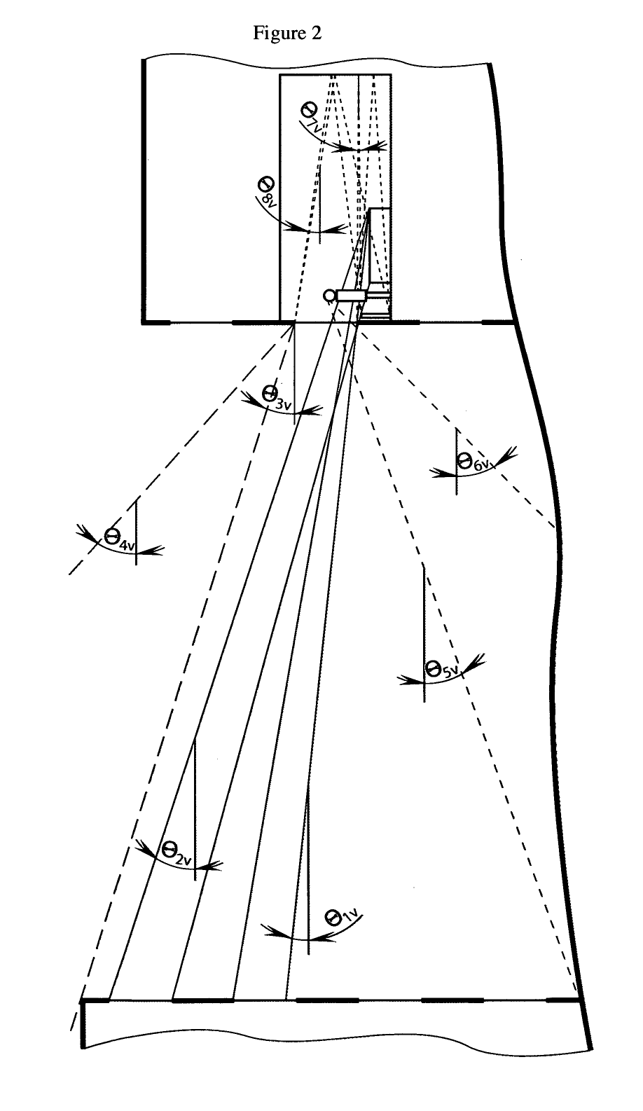

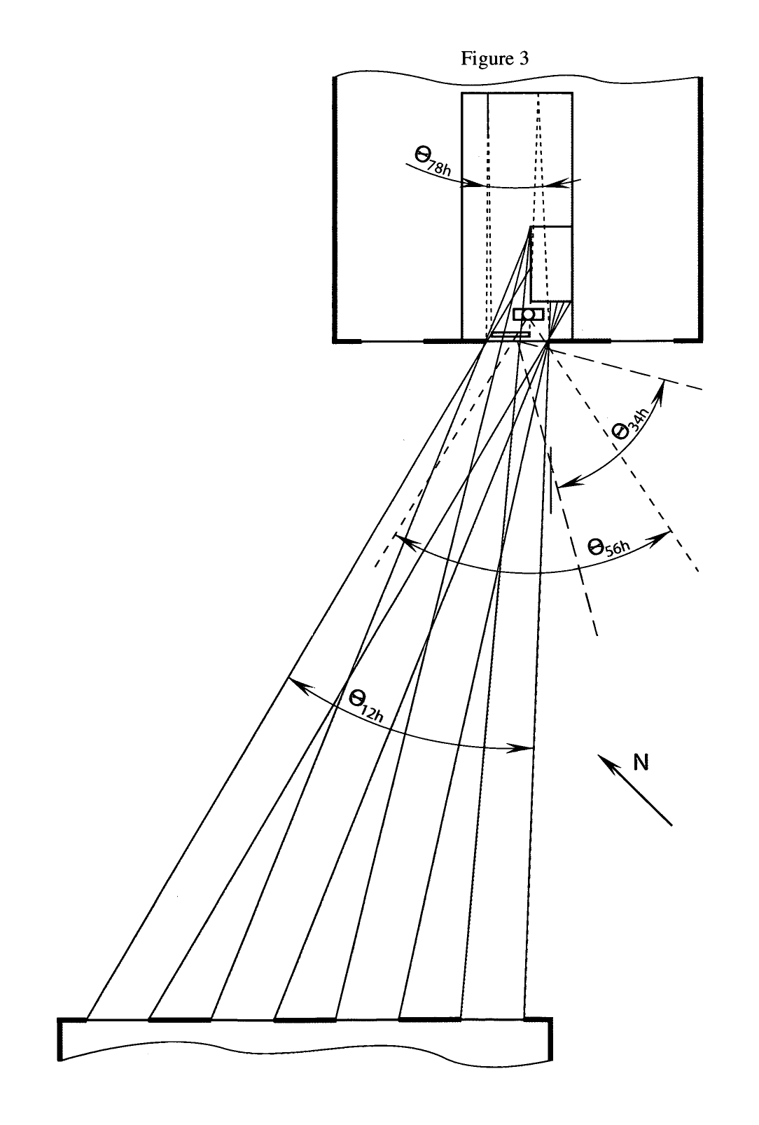

For complex satisfaction to these requirements by first feature of the invention, parameters of self-regulation of a given window construction and hierarchy of importance of requirements for this construction at the given azimuth of the window of the given floor in view of environmental buildings and at the given latitude and the complex curvilinear and continually changing trajectory of the sun seasonally and day are defined. It is defined, in what season and day in what zones of the room it is required to pass some value of the light stream, how to be protected from thermal losses in the cold season, which zones of the room should be provided by privacy and what view is necessary from the room, and also opportunity of optimum regulation without additional devices of redistribution of light streams is defined. On FIGS. 2 and 3 (gauge 1:100) as an example accordingly a section and a plan of territory with a settlement 3-storeyed building (a settlement room is on 2 floor, the window is oriented on the southwest) and a resisting 4-storeyed building are given. It is required to provide without application of additional devices optimum regulation of the gear transmission of light in the hottest period of year, to reduce thermal losses by the long-wave thermal beams of the heating appliance reflected from a wall, to provide privacy for a zone of a bed and the view of some territory from the room. Minimal Θ₁ᵥ, and maximal Θ₂ᵥ angles of incidence of beams (FIG. 2) show, that in a vertical plane protection of the zone of the bed only from windows of 4 floor and partially 3 floor is necessary, and a diapason of angles in a horizontal plane Θ₁₂ₜₕ (FIG. 3) shows, that the zone of the bed is accessible to beams from all 4 windows of 3 and 4 floors of the resisting building and protection of all width of the window is necessary. Solar beams in the vertical plane (FIG. 2) start to get in the settlement window atop of a roof of the resisting building at angle of incidence Θ₃ᵥ, and angle Θ₄ᵥ is the maximal angle of incidence of solar beams for the given latitude in the hottest period. However from FIG. 3 it is visible, that at the southwest azimuth of the window solar beams are most intensive at a horizontal diapason of angles Θ₃₄ₕ, that is, the resisting building at regulation of the gear transmission of light of the window can be not considered because optimum regulation of it is expediently just in this diapason of angles. Further, let, the view from the room in the vertical plane in a diapason of angles between Θ₅ᵥ and Θ₆ᵥ, in the horizontal plane in a diapason of angles Θ₅₆ₕ is necessary. The reflected thermal beams get on the window on all height at minimal Θ₇ᵥ and maximal Θ₈ᵥ angles of incidence (FIG. 2). From FIG. 3 it is visible, that they also get on all width of the window in a diapason of angles Θ₇₈ₕ, that is, all surface of the window should be protected from thermal losses.

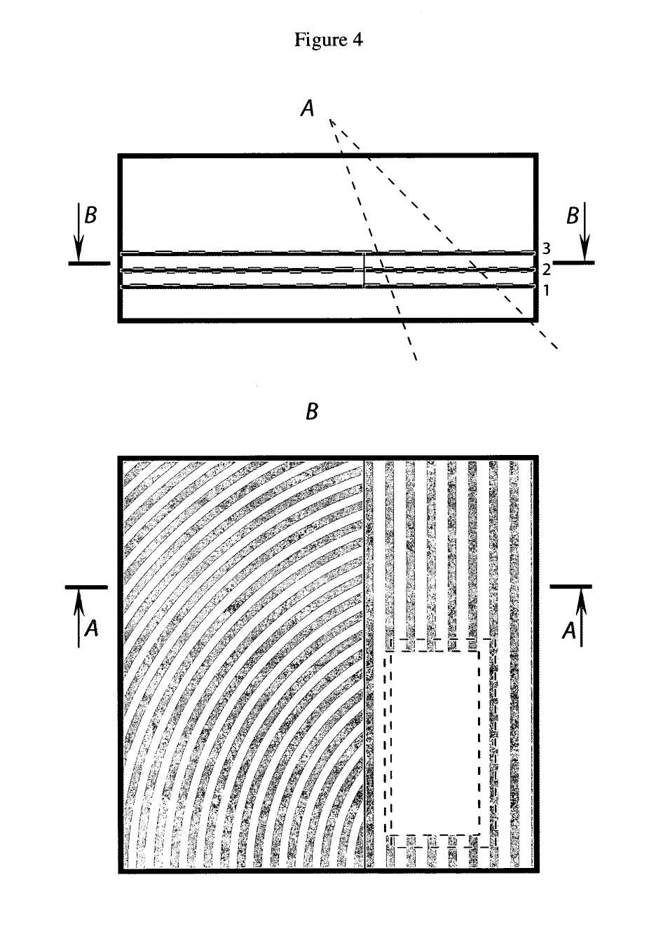

By second feature of the invention, in a view of hierarchy of shown requirements quantity and disposition of surfaces with alternating strips (at opportunity these surfaces are not chosen on two exterior surfaces of the construction with a view of protection of strips, or for this purpose a laminated glass with alternating strips between its interior layers are applied) are defined and parameters of strips on these surfaces are chosen. If it is necessary the chosen surfaces of the window construction are parted on zones with various optical characteristics (including with change of the spectrum, for example, in stained-glass windows). For the case featured on FIGS. 2 and 3, the put requirements are satisfied as follows. On FIG. 4 (gauge 1:15) the window of the settlement room with a three-layer glazing is given, all the sizes are taken from FIGS. 2 and 3. The thin continuous horizontal line parts the window on the inferior zone where providing of privacy is more important, and on the remained upper zone where optimum regulation of the gear transmission of light in the hottest period is necessary. For performance of these two problems on the basis of the data given on FIGS. 2 and 3 it is recommended to superimpose on both surfaces of second layer of the glazing alternating strips, on a view B strips diffusing the sunlight are colored grey (on a view A they are figured by thin black lines), strips of usual unprocessed glass are not colored (white). As well as on FIGS. 2 and 3, on FIG. 4 the refractive of light is not considered, and also disposition, shape and the sizes of all strips are figured schematically, expedients of precise calculation are given below. Parameters of strips on the inferior part of the window (on FIG. 4 only strips on the interior side of second layer of the glazing are figured) are selected so that on all width of the window alternating horizontal parallel strips (they could be inclined in view of shear of facades of two buildings from each other) in the diapason of vertical angles Θ₁ᵥ-Θ₂ᵥ (FIG. 2) provide the maximal impassability of direct beams. On both surfaces of the upper part of second layer of the glazing it is recommended to superimpose in this case the curvilinear alternating strips <<trackering>> the trajectory of the sun for the given latitude in the hottest period and providing, for example, the minimal gear transmission of light at the maximal angle Θ₄ᵥ of incidence of solar beams. On the view B (FIG. 4) dotted lines specify zones of the full gear transmission on first and second layers of the glazing for providing of the necessary view of territory from the room (FIGS. 2 and 3), that inappreciablly contradicts to privacy (two problems are crossly excluding each other). Inverse visibility from territory in the room is getting on a surface of a ceiling and is inessential (FIGS. 2 and 3). For diminution of thermal losses in the cold season it is recommended to superimpose on interior surfaces of first and third layers of the glazing the horizontal alternating strips maximum reflecting corresponding long-wave radiation in the diapason of angles Θ₇ᵥ-Θ₈ᵥ (FIG. 2) on all area of the window inside the room, and the transited through third layer of the glazing and reflected only from first layer beams provide some rise in temperature in two chambers of the glazing and attenuate difference of temperatures between the interior surface of the window and adjoining area of the room. On FIG. 4 in each zone alternating strips with constant width on the zone and constant optical characteristics of strips are figured. If it is necessary to achieve the different on the zone surface and in advance given allocation of the directional gear transmission of light at different angles or diapasons of angles of incidence of beams the corresponding geometrical sizes (widths of strips) and/or coefficients of the gear transmission of strips are selected, for example, gradient diminution or magnification of widths of alternating strips and/or coefficients of the gear transmission on the given surface in a perpendicular (normal) direction to strips, and also if necessary along strips is provided.

The important advantage of the invention is opportunity of regulation of the directional gear transmission of light in the oblique glazed constructions, and also in constructions with application of bent glasses. Alternating strips for a one-layer oblique construction with the bent glass are set as on FIG. 5 (figured schematically, parameters of strips are selected in view of curvature of surfaces and the refractive of light, the order of precise calculation is given below). In this case the problem of the maximal dispersion of a parallel bundle of beams impinging under some angle is solved, the part of beams are diffused on the receiving surface with diffusing strips (thick lines), the transited part—on the target surface.

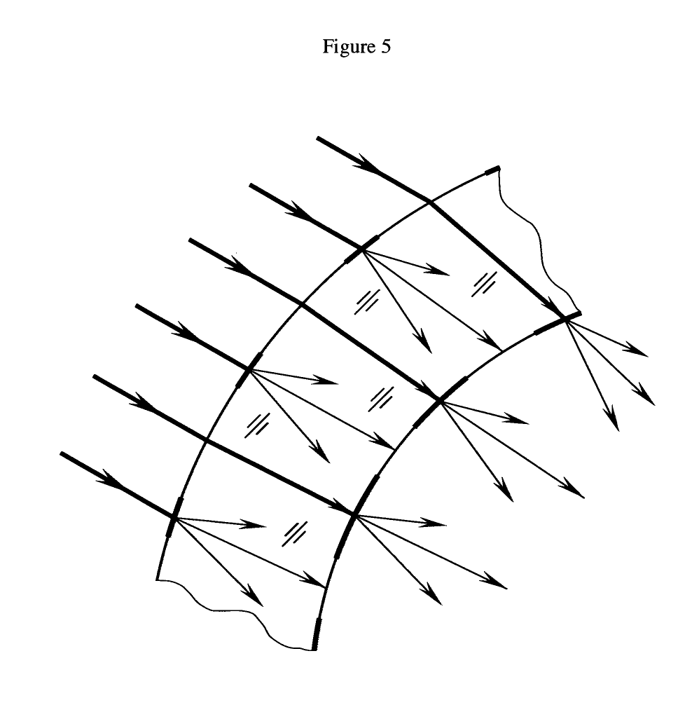

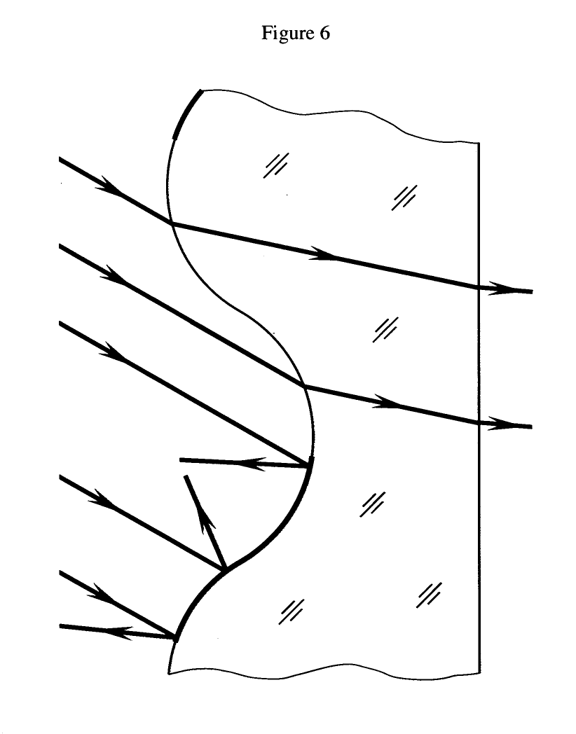

For restriction of hit in the room of direct solar beams, for the gear transmission preferentially of diffused light of the sky and reflected from surface of the Earth light (albedo) and for protection of the next buildings against overheat and drivers of transport against blinding from reflected by mirror windows and facades of multi-storey buildings beams (similar problems are featured in the literature: Solar Radiation Control in Buildings/E. L. Harkness, M. L. Mehta.—London (1978)) for refinishing of these windows and facades a corrugated glass with one corrugated surface with alternating strips is recommended, and some strips with a view of protection against sunlight with a mirror coat are assumed (construction against patches of light). A variant of such glazing is given on FIG. 6, thick lines specify strips reflecting the sunlight, other strips may be passing or diffusing, in this case passing ones are figured, that is, they pass a part of direct beams, and also a diffused light of the sky and albedo. It is visible, that all the reflected beams are guided above a horizontal and will not blind drivers of transport, etc. For diminution of the settling dust and influence of atmospheric precipitation the corrugated surface of the glazing is set from within (unlike FIG. 6).

In a case of application of <<thermal mirror>> in the construction at technological opportunity a membrane of <<thermal mirror>> is recommended to make as one of surfaces with alternating strips.

By third feature of the invention, in view of requirements of operation the most suitable expedient of making of strips are chosen, for example, at reconstruction of the existing window construction the simplest expedient is pasting a film with alternating strips. At the simultaneous solution of several problems, especially at regulation of the two-sided gear transmission (FIG. 4), expedients of making of strips in a complex, considering all requirements as far as greatest possible are selected, for example, some strip can reflect infrared radiation, but if necessary can pass or diffuse visible one, etc.

For window constructions first of two technical features, namely regulation of quantity of beams (values of light streams), transiting through the window construction directionally, dispersionless, depending on angles of incidence of beams is important first of all. Additional regulation of directions of transiting beams depending on angles of their incidence (second technical feature of the invention) for window constructions inessential though it inappreciable occurs because of change of exponents of the refractive after processing of strips, and the spontaneous regulation occurs under the scheme presented on FIG. 1. If it is necessary to provide the uniform gear transmission of light of the window constructions at change of the angle of incidence of beams the parameters of the alternating strips are selected so that maximum to cancel spontaneous regulation of the gear transmission of light (FIG. 1) in view of a motion of light spots from windows at a motion of the sun (for example, for providing of the most uniform illumination in a picture gallery).

Below peculiarities and technical features of the invention for other fields of its application are considered when there are any differences of its peculiarities and/or technical features, and also problems solved in a given scope, from the case of the architectural glazing.

At application of the invention in a glazing of vehicles the basic differences of its peculiarities and technical features in comparison with the architectural glazing are not present, except that in addition change of angles of incidence of the beams depending on requirements of a motion of the vehicle, especially automobile are considered. Except for similar problems solved at the architectural glazing, problem of protection of drivers from blinding light of headlights of other cars in particular diapasons of angles of incidence of beams on glasses and mirrors of the given car in view of spectrum of artificial light of headlights are solved.

In lighting equipment a light source is in immediate affinity from its glazed part, that is, the beams impinging on it in most cases are not parallel, besides the light source and the glazed part of lighting equipment are immobile from each other (angles of incidence of beams are constant), therefore at application of the invention these distinctive features from viewed above cases are considered. Purpose of lighting equipment guesses the maximal gear transmission of light through its glazed part at the given and constant angles of incidence of beams from the light source, therefore here geometrical and optical parameters of alternating strips are selected in view of self-regulation in the core for achievement of necessary allocation of a leaving light stream on demanded angles, including zone allocation, and also with change of the spectrum of radiation. At application of the invention in lighting equipment a problem of providing for each zone of the target surface of the glazed part of demanded values of light streams of the necessary spectrum for various directions of leaving beams is solved.

Optical systems with lenses, eyepieces, objectives, etc. should garble the least fashion shapes and the sizes of images transmitted through system of lenses, that is, at maximum passing of light to exclude contortions of transiting beams. At application of the invention if necessary zone allocation of the gear transmission of light on the surface of the lens both on ring, and on sectoral zones, including with different spectral characteristics of the gear transmission on zones is provided, for systems with several lenses the properties of their main planes are considered.

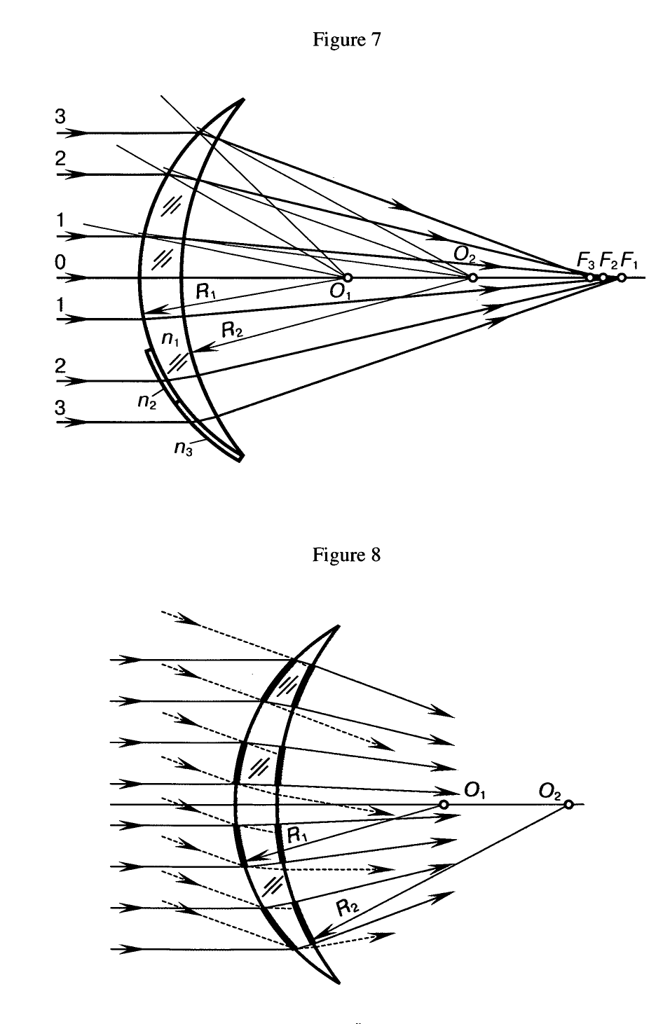

For rectifying of geometrical, for example, a spherical aberration, on one of surfaces of the lens the alternating ring strips of identical or different thicknesses and widths with different exponents of the refractive are superimposed. On FIG. 7 a section of such lens with exponents of the refractive of strips gradually decreasing to edges (n₃<n₂) of lens is figured, in the field of paraxial beams the strip is not superimposed or superimposed with same exponent of the refractive n₁, as at the lens. On the upper half of lens transiting of beams without participation of strips is shown, it is visible, that with removal of impinging beams from the axis of the lens aberration increases—the beam 2 hits the point F₂, and the beam 3 hits the point F₃, that is, even more leaves from point F₁ of hit of the paraxial beam 1. Exponents of the refractive n₂ and n₃ and thicknesses of strips are selected so that all beams are agglomerated in point F₁ (it is shown on the inferior half of lens on FIG. 7).

On FIG. 8 a lens with the alternating diffusing strips (oozed by thick lines) superimposed on its surfaces is figured. In this case by means of the relative disposition of strips on both surfaces a problem of providing of the maximal directional gear transmission of light at incidence of parallel beams (continuous lines) to coaxially direction of the axis of the lens is solved. From FIG. 8 it is visible, that at other angle of incidence of the beams figured by dotted lines, a part of the direct beams, which have transited in the same quantity, as well as at coaxial incidence of beams, through the receiving surface, is diffused on the target surface and the direct gear transmission decreases. Thus opportunity of self-orientation of the axis of the optical system in the direction to the light source on the maximum of the gear transmission of light or, on the contrary, opportunity of definition of the angle of incidence of beams on change of the gear transmission of light is provided.

For optimization of characteristics of <<enlightenment>> of optics, considering change of angles of incidence of parallel beams on a curvilinear surface of the lens in dependence on remoteness from the axis of the lens (FIG. 7) and corresponding change of the reflectivity, for different ring alternating strips such thicknesses and exponents of the refractive are selected (a strip can be multilayered with step change of the exponent of the refractive or even with its smooth change on thickness) that the corresponding interference arising on different radial zones provided the maximal gear transmission or reflection of light for each zone on all surface of the lens for the demanded diapason of wave length of impinging radiation.

So, at application of the invention in optical systems it is important to achieve its two technical features, and importance of this or that feature depends on the specific solving problem.

In glasses for correction of vision geometrical and optical parameters of alternating strips are selected for reception of demanding zone allocation of directions of beams leaving from glasses lenses (under the scheme presented on FIG. 7, strips can be superimposed also on both surfaces of the lens), if necessary the different on lens zones gear transmission of light are provided, including also of different diapasons of wave lengths. In sunglasses strips are crossly located in such a manner that to restrict hit on a retina of the eye of beams of harmful diapason (for example ultraviolet one) at the particular diapasons of angles of incidence of beams, for example, at high standing of the sun, by application of reflecting, absorbing and diffusing strips (under the scheme presented on FIG. 8). For medical glasses second technical feature is more important, for sun-protection glasses—first one.

Due to dispersion of light by means of the invention the selective gear transmission through the glazed construction of beams of only the particular diapason of wave length at the particular angles or diapasons of angles of incidence of achromatic or <<white>> light is provided. Most obviously it is possible to illustrate by an example with the prism though it is possible to apply in any glazed construction. On FIG. 9 a section of the prism with superimposed light-absorbing strips (are oozed by thick lines) on its receiving and target surfaces is figured. White light impinging under the set angle as a result of dispersion decays in the spectrum, and from the prism in a viewed case only the long-wave part of the spectrum with a smaller exponent of the refractive is left, other part is absorbed by strips on the target surface of the prism. Thus, for example, various light-color effects are gained. In this case of application both of technical features of the invention are important.

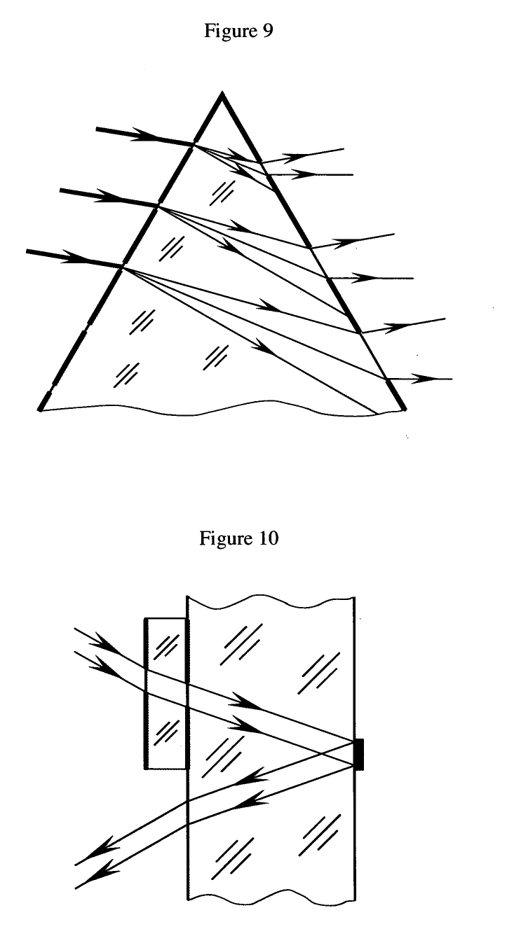

For reception of special light-color effects and illuminations, including in advertising, and also for protection against fakes of various empties or other glazed objects by means of corresponding optical and geometrical parameters of alternating strips visibility of any image or its part only under the particular and in advance given angles or diapasons of angles of observation are provided. As an example on FIG. 10 a section of the glazed object with the reflecting strip on its interior surface is given, and on exterior surface of the object the glass strip, passing an impinging light only under the particular angle (the diapason of angles) is attached. Beams transiting through object are reflected and leaved it also under the particular and in advance known angle under which the reflected beams can be observed. For magnification of a degree of protection or reception of additional effects on the reflecting strip an image and/or an inscription can be superimposed. The gained image reflected from the strip can be <<recolored>>, for this purpose the attached strip are made so that it passed beams only of the particular spectral diapason (for example, by a principle given on FIG. 9). The same principle (FIG. 9) are applied in holography to reception of more coherent light from a radiant, and the scheme featured on FIG. 10 are applied for reception of holograms of object only under the particular and in advance known angles, guiding the light stream by means of the relative disposition of strips on different surfaces and corresponding selection of their optical characteristics. In the given case both technical features of the invention are important.

### BRIEF DESCRIPTION OF DRAWINGS

Following figures relate to the description of the invention:

1) FIG. 1 is a scheme of transiting of beams through a unary plane-parallel glass at angles of incidence 30° and 60° (thickness of the lines showing the impinging, refracted, reflected and transiting beams, correspond to intensity of beams for the case with high coefficient of the gear transmission of light spread in glazed constructions);

2) FIG. 2 is a scheme of a vertical section of territory with two buildings for the solution of a problem of complex two-sided optimum gear transmission of light and heat (it is turned on 90° counter-clockwise);

3) FIG. 3 is a scheme of the plan of territory with two buildings for the solution of a problem of complex two-sided optimum gear transmission of light and heat (it is turned on 90° counter-clockwise);

4) FIG. 4 is a scheme for the solution of a problem of complex two-sided optimum gear transmission of light and heat through a window with the three-layer glazing (it is turned on 90° counter-clockwise);

5) FIG. 5 is a scheme of transiting of beams through one-layer bent glass with alternating strips on both surfaces;

6) FIG. 6 is a scheme of transiting and reflection of beams in a construction with one-layer corrugated glass with alternating strips on the receiving surface;

7) FIG. 7 is a scheme of rectifying of a spherical aberration by means of alternating strips with different exponents of the refractive;

8) FIG. 8 is a scheme of regulation of the gear transmission of light of spherical lens depending on the angle of incidence of beams;

9) FIG. 9 is a scheme of transiting of beams through prism with alternating strips on two its surfaces;

10) FIG. 10 is a scheme of reflection of beams from the glazed construction under in advance given angle;

11) FIG. 11 is a scheme for graphic-analytical calculation of regulation of the gear transmission of light through unary plane-parallel glass;

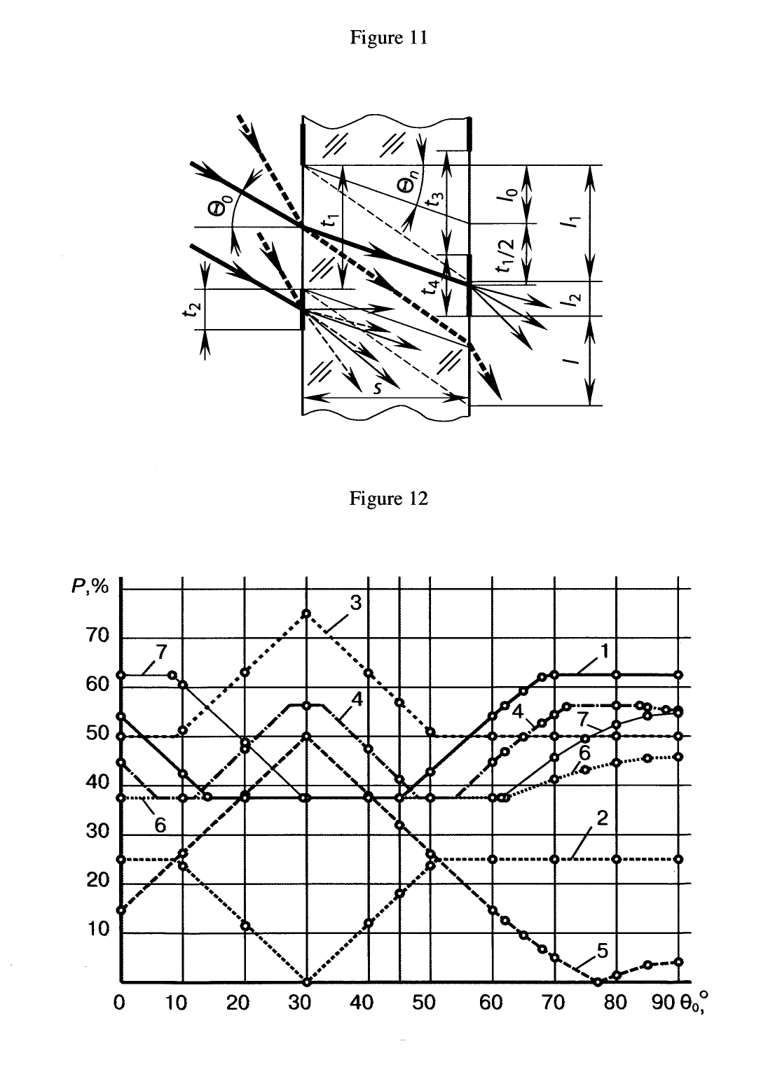

12) FIG. 12 is the graphs of dependence of the general percent of the gear transmission of not-diffused beams on angles of incidence for different widths of alternating strips and their different disposition.

### DESCRIPTION OF EMBODIMENTS

At embodiment of the invention the operations specified in its three features are carried out consistently.

By first feature of the invention, considering all geometrical and optical characteristics of any given glazed construction, settlement by laws and rules of geometrical optics and/or by means of natural measurements dependence of the relation of the light stream transiting directionally to the impinging light stream, and also dependence of directions of transiting of beams on angles of incidence of beams on the construction are defined, that is, the not depending on application of the invention existing parameters of self-regulation of the directional gear trans-mission of light and heat of the construction in its working diapason of wave lengths are defined. These two dependences provide achievement of both technical features of the invention in any glazed construction within the limits of physical legitimacies. However it is not enough for many glazed constructions. Therefore, for regulation of the gear transmission of light, as a rule, additional devices of redistribution of light streams are applied (for example, in window constructions), for regulation of directions of the gear transmission of beams a body of the glass is divided into zones with different exponents of the refractive (for example, in medical glasses). At application of the invention for such cases influence of these factors is considered and opportunity of effective regulation in limits demanded for the given construction and in the given requirements without application of additional devices or partitioning of the glass into zones is considered. Besides opportunity of expansion of existing limits of regulation and giving of new functions or properties to the construction by means of the invention are considered, including zone allocation of the gear transmission of light. Thus, at realization of first feature of the invention characteristics of the given glazed construction are analyzed and problem of improvement of those or other characteristics is put.

By second feature of the invention, it is defined, which changes are necessary for importing to the existing glazed construction to execute tasks in view under the given requirements, that is, quantity of surfaces which are necessary for making with alternating strips, and also optical and geometrical parameters of all strips are defined. Let us view an embodiment of the invention at the elementary case at demanded uniform on all area of the glazing regulation of the unilateral directional gear transmission of light depending on angle of incidence of parallel beams on a plane-parallel unary glass with high coefficient of transmission (the angle of incidence of beams changes only on vertical plane, projections of beams to horizontal plane at all angles of incidence are perpendicular to surface of glass).

On FIG. 11 in gauge 10:1 a scheme of transiting of beams through a unary flat glass with the exponent of the refractive n=1.5 and thickness s=4 mm is given, both surfaces of the glass have parallel alternating strips (the section is yielded perpendicularly to these strips). Continuous lines figure trajectories of transiting of beams at angle of incidence 30°, dotted—at 60° (the reflected beams having in this case considerably smaller intensity, are not figured). Thin lines figure sections of strips without processing of the glass, thick—with additional processing for diffusing of transiting beams. In this case widths of passing strips on the receiving and target surfaces are: t₁=3.0 mm and t₃=2.5 mm, widths of diffusing strips are accordingly: t₂=1.0 mm and t₄=1.5 mm. For the uniform regulation on all area a step (the total width of two next strips) is selected identical on both surfaces: t₁+t₂=t₃+t₄. Percentage relations of beams transiting directionally in relation to impinging ones for different angles of incidence are gained from relations of widths of strips: 100% is accepted, when the beam does not transit any diffusing strip, 0%—when it transits even one diffusing strip.

From FIG. 11 it is visible, that 25% of beams at any angle of incidence is diffused on the receiving surface, because t₂=0.25 (t₁+t₂). Refracted not diffused beams, transiting through the glass, get on second surface where the percent of diffused beams already depends on the angle of their incidence. The bandwidth of the gear transmission through the receiving surface at all angles of incidence is t₁=3.0 mm (boundaries are specified by continuous lines at angle of incidence 30° and dotted—at 60)°. As at angle of incidence 30° on the target surface beams are diffused in addition on width t₄ blanket percent P of not-diffused beams transiting through the glass makes:

P=(t₁−t₄)×100%/(t₁+t₂)=(3.0−1.5)×100%/(3.0+1.0)=37.5%.

At angle of incidence 60° accordingly percent is:

P=l×100%/(t₁+t₂)=2.1642×100%/(3.0+1.0)=54.105%,

Where l, mm—width of the general gear transmission at angle of incidence 60°, apparently from FIG. 11 it is equal to:

$$\begin{matrix}l = {t}_{1} - {l}_{2} \\ = {t}_{1} - ( 0.5 {t}_{4} + 0.5 {t}_{1} + {l}_{0} - {l}_{1} ) \\ = 0.5 {t}_{i} - 0.5 {t}_{4} - {l}_{0} + {l}_{1} = \\ = 0.5 \times 3 - 0.5 \times 1.5 - 1.4142 + 2.8284 \\ = 2.1642 mm ,\end{matrix}$$

Where l₀ and l₁, mm—biases of the refracted beams on the target surface concerning the receiving surface accordingly for angles 30° and 60° on FIG. 11 (generally for any angles of incidence—lᵢ, mm).

Biases lᵢ at transiting of beams through the plane-parallel glass at different angles of incidence Θ₀ and the given exponent of the refractive n and thickness of the glass s, mm, are defined from the settlement formula:

$${l}_{i} = \frac{s \times sin {Θ}_{0}}{n \times \sqrt{1 - \frac{{sin}^{2} {Θ}_{0}}{{n}^{2}}}}$$

For example, the biases calculated by this formula for the angles of incidence 30° and 60° are accordingly equal: l₀=1.4142 mm and l₁=2.8284 mm. The formula is gained from Snell's law and properties of trigonometric functions. Under Snell's law:

$$sin {Θ}_{n} = \frac{sin {Θ}_{0}}{n} .$$

From relations for the rectangular triangle with legs lᵢ and s (on FIG. 11 legs are l₀ and l₁ accordingly for angles 30° and 60°) it is:

$$tg {Θ}_{n} = \frac{{l}_{i}}{s} = \frac{sin {Θ}_{n}}{cos {Θ}_{n}} = \frac{{sin}^{′} {Θ}_{n}}{\sqrt{1 - {sin}^{2} {Θ}_{n}}} = \frac{sin {Θ}_{0}}{n \times \sqrt{1 - \frac{{sin}^{2} {Θ}_{0}}{{n}^{2}}}} .$$

From this formula the given above formula for calculation of biases lᵢ at any angle of incidence is gained. Formulas for definition of width of the general gear transmission and calculation of percent of the direct (not diffused) beams transiting through the glass for any angle of incidence are found from the analysis of graphic constructions, similar given on FIG. 11 for angles 30° and 60°. Dependence of the general percent P of the transiting of not-diffused beams on the angles of incidence, calculated on this procedure for angles of incidence from 0° up to 90° through everyone of 10° and for angle 45°, is given on FIG. 12 by line 1. In the diapason of angles of incidence approximately from 14° up to 45° the percentage gear transmission of light is 37.5%—it is equally and minimum in all this diapason, as all diffusing strip in width t₄ on the target surface (FIG. 11) in this diapason of angles of incidence overlaps a part of the beams which have transited directionally through the receiving surface, and at angle of incidence 30° the diffusing strip t₄ is precisely in centre of the transmission band, that is, at angles of incidence, just close to 30°, will be the minimum of the gear transmission. The maximum of the gear transmission by calculations is at angles of incidence approximately from 70° up to 90° (FIG. 12, line 1). For improvement of character of the line 1 in some diapasons at calculations values of percent of the gear transmission for the intermediate angles are found (it is similarly and for other curves given below).

If it is necessary to narrow the diapason of the identical minimum direct gear transmission at angles of incidence, close to 30°, width t₄ of the diffusing strip on the target surface concerning its centre upwards and downwards (on FIG. 11) at constant width t₁ of the passing strip on the receiving surface is incremented. At equality of widths of these strips (t₁=t₄=3 mm, hence, t₂=t₃=1 mm) 100% of the beams impinging under the angle 30°, will be diffused: 25% will be diffused on the receiving surface (t₂=0.25 (t₁+t₂)), the others of 75%—on the target surface. Thus, for the angle 30° the directional gear transmission of light will be equal to 0%. Results of calculation on the given above procedure under the viewed requirement t₄=t₁=3 mm for all angles of incidence are figured on FIG. 12 by line 2. In this case the maximum of the percentage gear transmission (25%) is in the diapasons from 0° up to 9° and from 51° up to 90°. By line 3 on FIG. 12 the inverse case when the width of passing strips on both surfaces is identical (t₁=t₃=3 mm) is figured, and steps of strips on two surfaces are shifted so that all not-diffused on the receiving surface at the angle of incidence 30° beams have transited as well not-diffused through the target surface, the width of diffusing strips also is identical (t₂=t₄=1 mm). Because t₁=0.75 (t₁+t₂) the maximum of the direct percentage gear transmission at the angle of incidence 30° is equal to 75%. For other angles the gear transmission is calculated on the given procedure, the minimum of the percentage gear transmission (50%) is in diapasons approximately from 0° up to 9° and from 51° up to 90°. Lines 2 and 3 on FIG. 12 are symmetric concerning a horizontal, because passing and diffusing strips on the target surface are exchanged the friend by the friend.

By line 4 on FIG. 12 the case, unlike viewed above, is presented when steps on two surfaces are not equal (t₁=3 mm; t₂=1 mm; t₃=1.25 mm; t₄=0.75 mm), that is, (t₁+t₂)=2 (t₃+t₄)—the step on the target surface twice is less. Steps are shifted for a maximum of the gear transmission at 30°, as well as in the previous case, —the centre of the passing strip in width t₃ coincides on the target surface with the refracted beam at the angle of incidence 30°, however the maximal percent of the gear transmission because of diminution of width of the passing strip has decreased from 75% to 56.25% (FIG. 12, lines 3 and 4) and now the maximum is not only at angle 30°, but also in some diapason of angles symmetrically concerning this angle (the same is characteristic also for two minimums of the gear transmission concerning angles approximately 9° and 51)°. Besides second maximum of the gear transmission in 56.25% in the diapason of angles of incidence approximately from 72° up to 83° is observed, that also is consequence of diminution of the step on the target surface.

Lines 1-4 on FIG. 12 show ample opportunities of selective regulation of the gear transmission of light at constant widths of alternating strips on the receiving surface by change of width of strips and their dispositions only on the target surface. By line 5 on FIG. 12 the case with identical widths of all alternating strips on both surfaces (t₁=t₂=t₃=t₄=2 mm) is figured, and the step is shifted so that all not-diffused on the receiving surface at the angle of incidence 30° beams have transited as well not-diffused through the target surface. Because t₁=0.5 (t₁+t₂) the maximum of the direct percentage gear transmission at the angle of incidence 30° is equal to 50%. In this case the minimum of the percentage gear transmission (0%) is at the angle approximately 77°.

Thus, choosing widths of the alternating passing and diffusing strips and their relative disposition on two surfaces, various opportunities of selective regulation of the gear transmission of light are provided, for example, achievement of minimum or maximum of the directional gear transmission at any angles and/or diapasons of angles of incidence (FIG. 12). For achievement of the maximum of the gear transmission at any angle of incidence steps of strips on different surfaces are shifted so that all the beams which have been not diffused on the receiving surface, have transited not-diffused also through target one, and widths of passing strips are selected identical on both surfaces, and the magnification of these widths in relation to widths of diffusing strips means growth of the percentage directional gear transmission (it is visible from comparison of lines 3 and 5 on FIG. 12 at angles, close to 30)°. For achievement of the maximum of the gear transmission at any diapason of angles of incidence symmetrically concerning any angle of incidence width of passing strips on the target surface is chosen greater, than on the receiving one (then, for example, on the line 3 the maximum of 75% would be for the diapason of angles, close to 30°, and this diapason that would be wider, than excess of widths of passing strips on the target surface is more), or smaller (then value of the maximum in diapason of angles of incidence about 30° would be less than 75%, and at diminution of width of the passing strip by the target surface concerning receiving one value of the maximum would decrease also, and the diapason of angles with this maximum of the gear transmission, on the contrary, would be dilated). It is obvious, that the 100% directional gear transmission can be achieved as a limit at the zero width of diffusing strips on both surfaces, when there is no alternating strips on them and when surfaces of the glass are not subjected to additional processing. For achievement of the minimum of the gear transmission (0%) at any angle of incidence steps of strips are shifted so that all the beams which have been not diffused on the receiving surface, diffused on target one, and widths of passing strips on the receiving surface and diffusing ones on the target surface are selected identical (line 2 on FIG. 12 at angle 30)°. For the zero gear transmission in the diapason of angles the width of the diffusing strip on the target surface in comparison with receiving surface is incremented, and the more there is this odds, the more widely the diapason. Comparison of lines 1 and 2 shows, that is possible to provide a nonzero minimum of the gear transmission only for the diapason of angles, but not for the particular angle, and for expansion of this diapason the width of diffusing strip on the target surface is reduced. On lines 2 and 4 it is visible, that maximum of gear transmission can be in two diapasons of angles of incidence, and on lines 3 and 4—minimum of gear transmission also can be in two diapasons.

The cases viewed above show, that relations of widths of alternating strips on each surface and shift of their steps influence on regulation of the percentage gear transmission depending on angle of incidence of beams at the same step on the receiving surface (lines 1-5 on FIG. 12). Distinction of steps on two surfaces also influences character of regulation, and for uniform regulation of the gear transmission of light on all area of the glazed construction steps are selected identical (all lines on FIG. 12, except for 4) or multiple (the line 4). At equality of steps on both surfaces value of the step also influences character of regulation. On FIG. 12 a line 6 presents the case when widths of all strips and, hence, both of the steps are incremented twice in comparison with FIG. 11 (t₁=6 mm; t₂=2 mm; t₃=3 mm; t₄=5 mm) at constant other parameters. From 0° approximately up to 62° the level of the gear transmission is constant and equal to 37.5% (as minimum of the gear transmission on the line 1), and then it increases slowly. That is, for impairment of the degree of regulation both on diapasons of angles, and on percentage gear transmission, widths of all strips are incremented (it is visible from comparison of lines 1 and 6 on FIG. 12). Impairment of regulation of the gear transmission depending on angle of incidence speaks, that at calculations of percent of the gear transmission the sizes of biases lᵢ at all angles of incidence from 0° up to 90° become much less widths of diffusing and passing strips (see calculation of the general width l of the gear transmission for angle 60° on FIG. 11) and change of these biases gradually ceases to influence character of regulation (for example, at further magnification of all strips horizontal site of line 6 would be displaced more to the right of angle 62°) and for each thickness of the glass there are greatest limiting widths of strips when the level of the gear transmission is identical at any angles of incidence, that is, regulation is stopped (line 6 would become horizontal on all site). Such legitimacy is characteristic for all other cases, including for the lines 2-5 on FIG. 12, as just change of biases lᵢ at change of angles of incidence defines change of percent of the gear transmission. Thus, for more intensive regulation the sizes of widths of strips are selected of one order with values of biases lᵢ at given thickness and exponent of the refractive of glass. On any of two surfaces with alternating strips the inferior limit of widths of diffusing or passing strips is 0 mm, that is, accordingly the beams completely transit through this surface, or completely are diffused by it.

The angle of incidence 30° is taken as characteristic settlement angle of incidence at the cases presented on FIG. 12 by lines 1-6 and their further analysis, that is, the beam impinging under this angle transits after the refractive through centre of the diffusing or passing strip on the target surface (for example, as on FIG. 11), however similar graphic-analytical calculation on the given procedure can be lead for any angle of incidence, proceeding from requirements to regulation in a concrete case. For example, for comparison on FIG. 12 by line 7 a case is presented, when only steps are shifted at all other constant parameters of FIG. 11 for the minimum of the gear transmission at angle of incidence 45°, instead of 30°, that is, at angle 45° the refracted beam transits through centre of the diffusing strip on the target surface. Now the maximum of the gear transmission is at angles from 0° approximately up to 9°, the minimum—approximately from 30° up to 61°, that is, values of maximums (62.5%) and minimums (37.5%) on lines 1 and 7 coincide owing to identical widths of all strips. However character of regulation because of magnification of shift of steps has changed—all line has moved to the right approximately on 15°, as one would expect at transition from 30° up to 45°, and at greater angles of incidence the percent of the gear transmission has decreased.

Thus, at the set initially parameters of glazed construction and requirements of its interaction with the impinging light stream at application of two surfaces with alternating strips in various cases (FIG. 12) following blanket legitimacies of regulation of the percentage directional gear transmission of light are found out:
At angles of incidence from 0° approximately up to 60° dependence of regulation practically is a rectilinear broken line, that is, strictly horizontal (in cases when the width of the gear transmission on the target surface remains identical in some diapason of angles of incidence), or practically rectilinear oblique (the width of the gear transmission varies practically proportionally, as differences between biases lᵢ, calculated for given thickness and exponent of the refractive of the glass, are almost identical through everyone of 10° in this diapason), and angles of slope of lines are identical even to cases with the different chosen characteristic angles, that is visible from comparison of lines 1-5 for the characteristic angle 30° and line 7—for 45°;
At greater angles of incidence (70°-90°) the degree of regulation goes down—lines 1-3 are horizontal (regulation depending on angle of incidence misses), and lines 4-7 are slanting (regulation is weaker, than at smaller angles, that speaks the weak change of sine of greater angles known from trigonometry, because of what the absolute difference between the calculated biases lᵢ through everyone of 10° at angles 70°-90° is much less, than in diapason 0°-60°, but namely this difference defines the degree of change of the gear transmission inside of each diapason in 10°), —however for the overwhelming majority of the glazed constructions, for example, the windows, regulation at greater angles of incidence (70°-90°) is not greatly demanded;
At enough greater angles of incidence (60°-90°) all lines, except for its horizontal sites, start to be bent more strongly, as despite of diminution of the absolute value, differences between biases lᵢ through everyone of next 10° in this diapason differ from each other in the greater degree, than at angles up to 60°,
At angles of incidence from 0° approximately up to 60° dependence of regulation is symmetrical concerning the chosen characteristic angle of shift of steps (the lines 1-6 for angle 30° and line 7 for angle 45°), as differences of biases lᵢ are almost identical through everyone of 10° in this diapason, and the refracted beam at the characteristic angle of incidence transits through centre of the diffusing or passing strip on the target surface and there are accordingly passing or diffusing strips of identical width to each case on both sides from it.

The procedure of embodiment of the invention viewed above allows gain its first technical feature—selective regulation under in advance given law of quantity of the beams transiting through the construction directionally depending on angles of their incidence. For simultaneous reception of second technical feature—selective regulation of directions of beams transiting through the construction depending on angles of their incidence—passing strips on the receiving and/or target surface are made with necessary thickness of the glass with other exponent of the refractive (see FIG. 7 and explanatories to it), thickness and exponent of the refractive are chosen on the basis of graphic-analytical calculations according to rules of geometrical optics. If such strips are applied on the receiving surface change of refraction angles of beams and influence of it on calculation of shift of steps of alternating strips on two surfaces are considered.

At embodiment of the invention in the cases differing from viewed above elementary case (FIGS. 11 and 12), the featured procedure of calculations on the basis of rules of geometrical optics is applied as follows:
If zone regulation of the gear transmission of light is necessary parameters of alternating strips are counted separately for each zone with demanded uniform intrazonal regulation (FIGS. 2-4), and the sizes and configuration of zones depending on shape of the given glazed construction can be any, quantity of zones with different parameters of the gear transmission of light can be unlimited, namely if non-uniform regulation on the surface of the glazed construction or on any zone and in any direction is necessary changing widths and/or other geometrical and optical parameters of alternating strips are chosen (for example, gradient change of parameters when each subsequent strip differs from previous on some parameters, and not only two types of strips as, for example, passing and diffusing strips on FIG. 11 can alternate, but also few types of strips and in any order can do), including similar changes of parameters also along strips (for example, the strip can be with changeable width, intermittent, with changing exponent of the refractive, etc.);
The quantity of surfaces with alternating strips is chosen more than two, for example, if two-sided regulation is necessary, as on FIGS. 2-4, thus cross influence of parameters of these surfaces against each other is considered—in this case (FIG. 4) in the upper zone of the window diffusing strips on both surfaces of second layer of the glazing should pass whenever possible the long-wave radiation, in turn, strips reflecting the long-wave radiation from first and third layers should pass the sunlight;
For protection against influence of exterior factors (for example the atmospheric phenomena on window constructions) surfaces with alternating strips are chosen on different layers of the glazing inside of the construction and, accordingly, at calculation distances between layers of the glazing and the sort of the substance filling space between layers of the glazing (its influence on exponents of the refractive) are considered, in constructions with corrugated glass the corrugated surface with alternating strips settle down on the interior surface (unlike FIG. 6);
In constructions with curvilinear shapes of the glazing the angles of incidence, reflection and refractive of beams are defined concerning normals to curvilinear surfaces, and shapes of strips can be as rectilinear (FIGS. 5 and 6), so ring (FIGS. 7 and 8);
At the complex curvilinear motion of the light source and/or the glazed construction from each other (for example, at the motion of the sun concerning the window) it is considered, that angles of incidence of beams change from 0° up to 90° not only in one coordinate plane (on FIG. 11 angles of incidence change only in the vertical plane), but also in another, hence, for each particular angle of incidence of the beam the scheme of its transiting through the section of the glazed construction by the plane transiting through this beam and perpendicular to the flat receiving surface (for the curvilinear receiving surface—to the plane, tangential to it in the point of incidence of this beam) is carried out, that complicates calculations a little and leads to curvilinear shapes of alternating strips, however allows to reach thus optimum regulation of the gear transmission of light as though “trackering” the trajectory of the motion of the light source concerning the construction (at calculations of regulation of the gear transmission of light of window constructions during daylight hours for the particular season the corresponding trajectory of the sun concerning the window is considered, that is, change of the azimuth and heights of standing of the sun at the given latitude of northern or southern hemisphere, and optimum parameters of all alternating strips for the given azimuth of orientation of the window and its vertical, oblique or horizontal disposition, and also its flat or curvilinear shape are counted);
In corresponding cases at calculations non-parallelism of impinging beams is considered (for example, at the close disposition of the light source to the glazed construction beams are radial);
Depending on carried out problems following types of alternating strips with demanded characteristics in all spectral diapason viewed for the given scope or only in any diapason of the spectrum are applied: passing with possible in greater coefficient of the gear transmission of light (sites of the surface of the glazed construction, not subjected to additional processing, or passing strips with other exponent of the refractive, than at the glass, as on FIG. 7, that is, passing-refracting strips, including multilayered strips with gradually changing of exponent of the refractive), reflecting with the different reflectivity (FIGS. 6 and 10, a part of the light stream is reflected also from any other strips), absorbing with the different coefficient of absorption (FIG. 9, and on FIG. 8 instead of diffusing strips it is possible to apply absorbing ones, the glass and any strips also absorb a part of the light stream) and diffusing with the different degree of dispersing (FIGS. 5, 8 and 11, the glass and any strips also diffuse a part of the light stream).

At application of the invention together with additional devices of redistribution of light streams calculations essentially do not differ from the above-stated, however it is necessary to consider the contribution of these devices to general (combined) regulation, and also changes which they import to calculations, for example, blinds at their outside disposition depending on the standing of their lamellas change both intensity of light impinging on the window surface, and direction of impinging beams, all this must be considered at calculations of regulation of the gear transmission of light of given glazed construction.

To simplification of calculations on the set forth above procedure existing computer programs of calculation are applied or new programs are made in view of specificity of calculations and variety of variables on which parameters of the gear transmission of light and heat of the glazed constructions are depended in various cases of application.

The procedure of embodiment of the invention given above is grounded on graphic-analytical calculations of general percent of the directional gear transmission at different angles of incidence of beams under the relation of the total area of the target surface through which the directional (not diffused) beams transit, to the area of all receiving surface (it is similar also for cases when number of surfaces with alternating strips more than two). For example, for the case viewed on FIG. 11, the percent of the gear transmission is certain on relations of widths of strips, however this simplification approaches only for rectangular constructions, when as in this case, the width of the construction is constant. In the general case the percent of the gear transmission is defined on relations of the areas, including curvilinear surfaces and shapes of alternating strips. For final practical application of the invention at definition of the directional gear transmission of light of the glazed construction at different angles of incidence in addition to general percent of the gear transmission it is necessary to consider following physical factors, not dependent on the invention, but influencing its application and the total regulation of the gear transmission of light:
At magnification of the angle of incidence of beams the reflectivity and, hence, the reflected part of the light stream is incremented;
At magnification of the angle of incidence of beams at constant intensity of impinging light (the relation of the light stream to the area of the receiving plane, perpendicular to the direction of beams, that is, at the angle of incidence 0°) the value of light stream really impinging on the area of receiving surface decreases;
In some cases intensity of the light source is changed (for example, intensity of solar beams depends on time of day);
At constant thickness of the glass with magnification of the angle of incidence lengths of the trajectory of refracted beams transiting through the glass are incremented, and hence, the quantity of the absorbed light stream is incremented;
At diminution of widths of alternating strips the degree of influence of dispersion, diffraction, interference, various kinds of aberrations, etc., and also the multiple reflection inside of the glass from its exterior surfaces is incremented, that is especially important for precision optical systems.

In cases when precomputations of characteristics of regulation can be insufficiently exact because of impossibility of the high-grade account of all influencing factors, they are discovered by means of a pre-production model of the glazed construction with the given geometrical and optical parameters of alternating strips on the basis of measurements (for example, by a luxmeter) of the impinging and transited illumination intensity at different angles of incidence, thus to be considered, that at presence of diffusing strips the luxmeter will measure as well the diffused radiation, that is, to definition of parameters of regulation just only of the directional gear transmission only absorbing and reflecting strips at the given widths of all passing strips are applied.

Thus, at embodiment of second feature of the invention problems of improvement of those or other characteristics of given glazed construction without change of its basic purpose are solved, at opportunity existing limits of regulation are dilated and new additional functions and properties of construction are given.

By third feature of the invention, alternating strips with necessary geometrical and optical parameters are made on the chosen surfaces by the known technological expedients numbered above or any others, or the films with alternating strips in advance superimposed on them are pasted. For simplification of manufacturing of alternating strips masks with corresponding transmission zones to additional processing of the surface of the glass are applied that at any expedient of manufacturing of strips other part of the surface has been protected from processing influence. At use films with alternating strips, for example, in window constructions, in some cases for simplification the film with the same parameters is applied on different surfaces of the same window with necessary shift of strips.

I claim:

1. An expedient of regulation of a directional gear transmission of light of a glazed construction of any shapes, the sizes, purpose, quantities of layers of a glazing and types of the applied glasses, consisting that owing to dependence of a coefficient of reflection of a receiving surface of the construction and directions of beams transiting through the construction on an angle of incidence of beams at change of this angle (FIG. 1) corresponding values of coefficients of gear transmission and absorption are redistributed also and characteristics of the directional gear transmission of light, and in view of thermal energy of light also the gear transmission of heat of all construction are changed, differing that with the purpose of additional regulation of one- or two-sided characteristics of the directional gear transmission of light selectively depending on angles of incidence of beams one or several surfaces of the glazed construction are made not homogeneous on optical properties, but in a form of alternating parallel and/or curvilinear strips with different coefficients of reflection, gear transmission and absorption, having such compositions, exponents of the refractive, the shape, the sizes and located from each other both on everyone, and on different non-uniform surfaces with alternating strips so that at the given angles or diapasons of angles of incidence of beams on the glazed construction through all glazed area equally or with zone allocation only the demanded just at the given angles or diapasons of angles of incidence and in advance defined by rules of geometrical optics part of beams of the demanded diapason of wave lengths directionally transited, but other part of beams—was reflected, absorbed and diffused (FIG. 11).

2. The expedient, defined in claim 1, differing that necessary quantity of surfaces with alternating strips in the glazed construction of any shapes, the sizes, purposes and types of applied glasses in case of not unary glazing is made on different layers of the glazing of the construction for regulation of one- or two-sided characteristics of the gear transmission of light of all glazed construction (FIG. 4).

3. The expedient, defined in claim 1, differing that in the glazed construction, at least in one layer of the glazing, the plane-parallel leaf glass is applied and its both surfaces are made in the form of alternating parallel and/or curvilinear strips (FIG. 11).

4. The expedient, defined in claim 1, differing that in the glazed construction, at least in one layer of the glazing, the glass with surfaces in the form of nonparallel planes (FIG. 9) is applied and both surfaces of the glass are made in the form of alternating parallel and/or curvilinear strips.

5. The expedient, defined in claim 1, differing that in the glazed construction, at least in one layer of the glazing, the glass with curvature of one or both surfaces is applied, and both surfaces of the glass are made in the form of alternating parallel and/or curvilinear strips (FIGS. 5 and 8).

6. The expedient, defined in claim 1, differing that in the glazed construction, at least in one layer of the glazing, the laminated glass is applied, and alternating strips are made inside of the laminated glass between its layers and/or on one or both outside surfaces.

7. The expedient, defined in claim 1, differing that in the glazed construction, at least in one layer of the glazing, the corrugated glass with one (FIG. 6) or both corrugated surfaces of the particular shapes, the sizes and disposition is applied, and alternating strips are made on one or both surfaces of the glass.

8. The expedient, defined in claim 1, differing that in case of application of [symbol] thermal mirror [symbol] in the glazed construction a membrane of [symbol] thermal mirror [symbol] is made as one of surfaces with alternating strips.
